(19) United States
(12) Patent Application Publication
(10) Pub. No.: US 2003/0212207 A1
(43) Pub. Date: Nov. 13, 2003

(54) Process for the solvent-free continuous preparation of a polymeric composition prepared from polymers and thermosets

(75) Inventors: Joern Volker Weiss, Haltern (DE); Thomas Weihrauch, Duelmen (DE); Werner Grenda, Herne (DE); Silvia Herda, Herne (DE); Klaus Behrendt, Herne (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DE GUSSA AG, Duesseldorf (DE)

(21) Appl. No.: 10/306,222

(22) Filed: Nov. 29, 2002

(30) Foreign Application Priority Data
May 10, 2002 (DE) 102 21 049.7
May 10, 2002 (DE) 102 21 048.9

(51) Int. Cl. C08L 75/00

(52) U.S. Cl. 525/131

(57) ABSTRACT

The invention relates to a process for the solvent-free continuous preparation of a polymeric composition comprising a polymer and a thermoset, where the thermoset is prepared in the polymer matrix from its corresponding starting components, by reaction in an extruder, intensive kneader, intensive mixer, or static mixer, through intensive mixing and rapid reaction by briefly heating and with subsequent cooling to isolate the final product.

### BACKGROUND OF THE INVENTION

### FIELD OF THE INVENTION

The invention relates to a process for the solvent-free continuous preparation of a polymeric composition comprising a polymer and a thermoset, where the thermoset is prepared in the polymer matrix from its corresponding starting components, by reaction in an extruder, intensive kneader, intensive mixer, or static mixer, through intensive mixing and brief reaction with introduction of heat and with subsequent isolation of the final product by cooling.

Polymer blends (PBs) are mixtures of two or more polymers or copolymers. These are prepared in order to improve the properties of an underlying polymer. PBs are divided into homologous (HPBs), miscible (MPBs), immiscible, and compatible products, and also polymer alloys. HPBs are mixtures which are composed of two chemically identical polymers which differ only in their molecular weight distributions. The mixtures are always homogeneous, and the mixture is thermodynamically stable. In contrast, MPBs are mixtures of polymers of different chemical structure, these being nevertheless thermodynamically stable. This very unusual situation occurs, for example, where the segments of the macromolecules to be mixed enter into specifically attractive interactions with one another (e.g. hydrogen bonds or dipole-dipole or ion-dipole interactions). The great majority of chemically different polymers are incompatible from a very low degree of polymerization upward, and their incompatibility continues to rise as chain length grows, as can be demonstrated on the basis of statistical/thermodynamic considerations and experimental findings. Decisive factors here relevant to the compatibility of the PBs are particularly their composition and pretreatment. Once the mixing procedure has taken place, if the opportunity for chain-movement and time have been sufficient to permit development of relatively large phase-separated regions, this is mostly observable from clouding of the material. PBs which are then generally termed compatible are those products which appear to the naked eye as homogeneous and whose physical properties are superior to those of the components of the mixture.

Improved compatibility of polymers A and B can be achieved through modification of polymer A by grafting-on small proportions of polymer B, or through adding AB block copolymers. In this system, graft copolymers or block copolymers form the boundary between A phases and B phases, thus tying these to one another. In these cases the term polymer alloys is used. Compatibility may also be brought about by adding certain additives. However, a maximum of homogeneous miscibility is by no means always desirable. For example, impact-modification of polymers such as polystyrene, or the preparation of thermoplastic elastomers, would not be achievable without phase separation. PBs have a very important economic role (Röpp Lexikon Chemie [Röpp's Chemical Encyclopedia]—Version 2.0, Stuttgart/New York: Georg Thieme Verlag 1999).

Polyester surface-coating resins often bear hydroxy groups as a functional group. Both liquid and solid products are used. A main application sector for these resins is the production of surface coatings and coating materials, which are likewise either liquid (e.g. coil coatings) or solid (e.g., powder coatings). Using appropriate hardeners which can react with the OH groups (e.g. polyisocyanates), the polyester resins are generally cured at an elevated temperature after application to a substrate, to give a long-lasting and tough film coating.

Thermosets are plastics which are produced by irreversible and close-knit crosslinking via covalent bonds starting from oligomers or prepolymers, or less often from monomers or polymers. The word “thermosets” here is applied both to the raw materials prior to crosslinking (e.g., reactive resins) and is also used as a collective term for the cured resins, which are mostly amorphous. At low temperatures, thermosets are energy-elastic, and even at relatively high temperatures they cannot undergo viscous flow, but behave elastically with very limited deformability (Röpp Lexikon Chemie [Röpp's Chemical Encyclopedia]—Version 2.0, Stuttgart/New York: Georg Thieme Verlag 1999).

One way of preparing a physical mixture of polymers, and specifically of polyester resin and thermoset, would be to use a considerable amount of mechanical energy to grind the cured thermoset and then to incorporate the ground material into the liquid or molten polyester (e.g. with the aid of a mixer or extruder). Naturally, this does not achieve genuinely homogeneous distribution of the thermoset in the polyester extending to the molecular range, since the maximum achievable fineness of the ground material sets effective limits for polyester/thermoset distribution.

Polymeric compositions are known from EM 01 226a. As described there, they are prepared batchwise in a mixer. A disadvantage of this method of preparation is that the polymers used (e.g. polyesters) continue to have relatively high viscosities even at temperatures of from 180 to 220° C., and these viscosities make it considerably more difficult to incorporate the thermoset starting materials (e.g. polyamine and polyisocyanate) rapidly and effectively. Since, as the amount of thermoset in the reaction mixture increases, the melt viscosity rises sharply, the use of a very powerful mixer assembly is required, and the circumstances described also severely limit the batch size for the batch process. For the industrial preparation of these products, the method described above is, therefore, very complicated and extremely ineffective.

It was therefore an object of the present invention to find a novel preparation process which does not have the disadvantages mentioned of the prior art.

Surprisingly, it has now been found that ideal distribution of the thermoset in polymers, and especially in polyesters, occurs if the thermoset is prepared entirely within the polymer or polyester. For this, the appropriate monomers, oligomers, and/or prepolymers are reacted within the polymer/polyester in an extruder, intensive kneader, intensive mixer, or static mixer.

The invention provides a process for the solvent-free continuous preparation of a polymeric composition through a conversion involving

A) at least one polymer,

B) amounts of from 0.5 to 50% by weight, based on the weight of A and B, of at least one thermoset,

by reacting in the polymer matrix A, during the above-mentioned conversion, of

1) at least one starting component having NH₂ groups and

2) at least one starting component having NCO groups,

where B1 and B2 simultaneously and independently have functionality ≧2, and at least one starting component with functionality >2 is present in amounts of from 0.5 to 100% by weight, based on the weight of B, in an extruder, intensive kneader, intensive mixer, or static mixer, through intensive mixing and rapid reaction by briefly heating and subsequent isolation of the final product by cooling.

A preferred embodiment provides a process for the solvent-free continuous preparation of a polymeric composition through a conversion involving

A) at least one polymer having OH groups, preferably a polyester and/or polyacrylate, whose OH functionality is ≧2, and

B) amounts of from 0.5 to 50% by weight, based on the weight of A and B, of at least one thermoset,

by reacting in the polymer matrix A, during the above-mentioned conversion, of

1) at least one starting component having NH₂ groups and

2) at least one starting component having NCO groups,

where B1 and B2 simultaneously and independently have functionality ≧2, and at least one starting component with functionality >2 is present in amounts of from 0.5 to 100% by weight, based on the weight of B, in an extruder, intensive kneader, intensive mixer, or static mixer, through intensive mixing and rapid reaction by briefly heating and subsequent isolation of the final product by cooling.

At thermoset contents of from 0.5 to 50% by weight, preferably from 2 to 40% by weight, homogeneous thermoset/polymer compositions are obtained which have physical properties (melting range, Tg, melt viscosity) which differ from those of the substances present separately after physical mixing. In contrast, the chemical reactivity of the polymer which does not participate in the polymerization reaction is retained. The resultant polymeric composition may then be further processed like the matrix polymer.

Suitable polymers A are in principle any of those which are known, e.g. polyolefins, polybutadienes, polystyrenes, polysiloxanes, polyamides, as long as their melting point is not higher than 220° C. Copolymers and block polymers are also suitable as polymer A, an example being styrene-diene copolymers.

Suitable polymers whose functionality is at least 2 are generally any of the polymers which have functionalities of this type, but in particular polyacrylates and polyesters having hydroxy groups.

Preferred polyesters, which contain hydroxy groups are prepared by polycondensation of suitable di- and/or polycarboxylic acids, or the corresponding esters and/or anhydrides, with di- and/or polyols. The condensation takes place in a manner known per se in an inert gas atmosphere at temperatures of from 100 to 260° C., preferably from 130 to 220° C., in the melt, or by an azeotropic method, e.g. as described in Methoden der Organischen Chemie [Methods of Organic Chemistry] (Houben-Weyl); Volume 14/2, pp. 1-5, 21-23, 40-44, Georg Thieme Verlag, Stuttgart, 1963, or in C. R. Martens, Alkyd Resins, pp. 51-59, Reinhold Plastics Appl. Series, Reinhold Publishing Comp., New York, 1961. The preferred carboxylic acids for preparing polyesters are aliphatic, cycloaliphatic, aromatic, and/or heterocyclic in nature, and, where appropriate, may have substitution by halogen atoms, and/or may have unsaturation. Examples of those which may be used are: succinic, adipic, suberic, azelaic, sebacic, phthalic, terephthalic, isophthalic, trimellitic, pyromellitic, tetrahydrophthalic, hexahydrophthalic, hexahydroterephthalic, di- and tetrachlorophthalic, endomethylenetetrahydrophthalic, glutaric, and 1,4-cyclohexanedicarboxylic acid and their anhydrides or esters. Particularly suitable compounds are isophthalic acid, terephthalic acid, hexahydroterephthalic acid, and 1,4-cyclohexanedicarboxylic acid.

Examples of polyols which may be used are monoethylene glycol, propylene 1,2- or 1,3-glycol, butylene 1,4- or 2,3-glycol, di-β-hydroxyethylbutanediol, 1,5-pentanediol, 1,6-hexanediol, 1,8-octanediol, decanediol, dodecanediol, neopentyl glycol, cyclohexanediol, 3(4),8(9)-bis(hydroxymethyl)-tricyclo[5.2.1.0^{2,6}]decane (Dicidol), bis(1,4-hydroxymethyl)-cyclohexane, 2,2-bis(4-hydroxycyclohexyl)propane, 2,2-bis[4-(β-hydroxyethoxy)phenyl] propane, 2-methyl-1,3-propanediol, 2-methyl-1,5-pentanediol, 2,2,4(2,4,4)-trimethyl-1,6-hexanediol, glycerol, trimethylolpropane, trimethylolethane, 1,2,6-hexanetriol, 1,2,4-butanetriol, tris(β-hydroxyethyl) isocyanurate, pentaerythritol, mannitol, sorbitol, diethylene glycol, triethylene glycol, tetraethylene glycol, dipropylene glycol, polypropylene glycols, polybutylene glycols, xylylene glycol, and/or the neopentyl glycol ester of hydroxypivalic acid. Preferred polyols are monoethylene glycol, neopentyl glycol, Dicidol, cyclohexanedimethanol, trimethylolpropane, and glycerol.

Amorphous polyesters prepared in this way preferably have an OH value of from 15 to 200 mg KOH/g, a Tg of from 35 to 85° C., a melting range from 60 to 110° C., and an acid value of <10 mg KOH/g. The molecular weights are preferably from 2000 to 7000.

Crystalline polyesters prepared similarly have an OH value of from 15 to 130 mg KOH/g, a Tg of from −50 to 40° C., a melting range from 60 to 130° C., and an acid value of <8 mg KOH/g. The molecular weights are preferably from 1800 to 6500.

Preferred acrylates which may be used and which contain hydroxy groups and have an OH value of from 20 to 150 mg/KOH, a molecular weight of from 1800 to 6000, and a Tg of from 30 to 90° C. are prepared by polyaddition of suitable ethylenically unsaturated monomers. Examples of these monomers are styrene, α-methylstyrene, C₂-C₄₀-alkyl acrylates or C₁-C₄₀-alkyl methacrylates, such as methyl methacrylate, ethyl acrylate, propyl methacrylate, isopropyl methacrylate, n-butyl methacrylate, isobutyl acrylate, tert-butyl methacrylate, pentyl methacrylate, n-hexyl methacrylate, n-heptyl methacrylate, n-octyl acrylate, 2-ethylhexyl acrylate, decyl methacrylate, lauryl methacrylate, palmityl methacrylate, phenoxyethyl methacrylate, phenyl methacrylate, cyclohexyl methacrylate, tert-butylcyclohexyl acrylate, butylcyclohexyl methacrylate, and trimethylcyclohexyl methacrylate, hydroxyalkyl esters of α,β-unsaturated carboxylic acids, e.g. of acrylic acid and/or methacrylic acid, having a primary OH group and a C₅-C₁₈-hydroxyalkyl radical, e.g. hydroxyhexyl acrylate, hydroxyoctyl acrylate, and the corresponding methacrylates, and reaction products of hydroxyethyl (meth)acrylate with caprolactone, and also monomers having secondary OH functions, for example adducts of glycidyl (meth)acrylate with saturated short-chain acids having C₁-C₃-alkyl radicals, e.g. acetic acid or propionic acid.

According to the invention, the thermoset B is prepared from its starting components in the polymer matrix A. The starting components B1 and B2 have functionality of ≦2.0, and in component B there must always be one starting component present whose functionality is >2, in amounts of from 0.5 to 100% by weight, based on the weight of B. It is in principle unimportant whether the amino component or the isocyanate component has functionality of >2, but it is preferable for the isocyanate component having functionality >2 to be used. The approximate molecular weight of the thermosets vary from 2000 to 70000, and are preferably greater than 4000.

In the composition, the amounts generally present of the thermosets B, based on the polymeric composition, are from 0.5 to 50% by weight, preferably from 2 to 30% by weight, based on the weight of A and B.

As component B2 for preparing the thermosets, use may be made of any of the known aliphatic, cycloaliphatic, araliphatic, or aromatic isocyanates or their isocyanurates, in pure form or in the form of any desired mixtures with one another. Examples which may be listed are: cyclohexane diisocyanates, methylcyclohexane diisocyanates, ethylcyclohexane diisocyanates, propylcyclohexane diisocyanates, methyldiethylcyclohexane diisocyanates, phenylene diisocyanates, tolylene diisocyanates, bis(isocyanatophenyl)methane, propane diisocyanates, butane diisocyanates, pentane diisocyanates, hexane diisocyanates, such as hexamethylene diisocyanate (HDI) or 1,5-diisocyanato-2-methylpentane (MPDI), heptane diisocyanates, octane diisocyanates, nonane diisocyanates, such as 1,6-diisocyanato-2,4,4-trimethylhexane or 1,6-diisocyanato-2,2,4-trimethylhexane (TMDI), nonane triisocyanates, such as 4-isocyanatomethyl-1,8-octane diisocyanate (TIN), decane di- or triisocyanates, undecane di- or triisocyanates, dodecane di- or triisocyanates, isophorone diisocyanate (IPDI), bis(isocyanatomethylcyclohexyl)methane (H₁₂MDI), isocyanatomethyl methylcyclohexyl isocyanates, 2,5(2,6)-bis(isocyanatomethyl)bicyclo[2.2.1]heptane (NBDI), 1,3-bis(isocyanatomethyl)cyclohexane (1,3-H₆-XDI), or 1,4-bis(isocyanatomethyl)-cyclohexane (1,4-H₆-XDI). The list includes all of the regio- and stereoisomers of the isocyanates mentioned by way of example. Preference is given to the use of HDI, IPDI, MPDI, TMDI, 1,3- and 1,4-H₆-XDI, NBDI, and mixtures of HDI and IPDI. Preferred polyureas for the process of the invention are those composed of IPDI, IPDI isocyanurate, HDI, or HDI isocyanurate, or mixtures thereof.

For the purposes of the invention, any of the aliphatic, (cyclo)aliphatic, cycloaliphatic, or aromatic diamines and/or polyamines (C₅-C₁₈) may be used as component B1.

Suitable diamines are 1,2-ethylenediamine, 1,2-propylenediamine, 1,3-propylenediamine, 1,2-butylenediamine, 1,3-butylenediamine, 1,4-butylenediamine, 2-(ethylamino)ethylamine, 3-(methylamino)propylamine, 3-(cyclohexylamino)propylamine, 4,4′-diaminodicyclohexylmethane, isophoronediamine (IPD), 4,7-dioxadecane-1,10-diamine, N-(2-aminoethyl)-1,2-ethanediamine, N-(3-aminopropyl)-1,3-propanediamine, N,N″-1,2-ethanediylbis(1,3-propanediamine), and also hexamethylenediamines, which may be substituted by one or more C₁-C₄-alkyl radicals. Mixtures of the above diamines may also be used. Isophoronediamine is preferably used.

Polyamines having more than 2 NH groups are also suitable, e.g. 4-aminomethyl-1,8-octanediamine, diethylenetriamine, dipropylenetriamine, and tetraethylenepentamine.

The thermosets prepared generally have an NCO/NH₂ ratio of from 0.8 to 1.2:1. If equimolar amounts are used with an NCO/NH₂ ratio of 1:1, the thermosets obtained in the polymers are continuously crosslinked, strong, and brittle.

For the purposes of the invention, preferred thermosets are those composed of IPD and IPDI, and/or IPDI isocyanurate and/or HDI, and/or HDI isocyanurate. These have molecular weights of above 4000 and contain at least 8% by weight, preferably 20% by weight, particularly preferably 40 to 100% by weight, of isocyanurates and/or amines with functionality >2, preferably isocyanurates, preferably IPDI isocyanurate and/or HDI isocyanurate. Polyureas composed of pure isocyanurates and IPD are also preferred.

In the preferred embodiment of the invention, from 3 to 20% by weight, particularly preferably 4, 5, 6, 7, 8, 9, 10, 11, 12, 13, 14, 15, 16, 17, 18, 19% by weight of thermoset are present in the polymeric composition, in particular in the OH-containing polyester or polyacrylate.

The principle of the process consists in reacting the reactants continuously in an extruder, intensive kneader, intensive mixer, or static mixer, through intensive mixing and rapid reaction by briefly heating.

The process uses temperatures from 10 to 325° C., the temperature varying with the product, as shown by the examples.

The residence time of the starting materials in the above mentioned units is usually from 3 seconds to 15 minutes, preferably from 3 seconds to 5 minutes, particularly preferably from 5 to 180 seconds. The reactants are rapidly reacted by briefly heating at temperatures of from 25 to 325° C., preferably from 50 to 250° C., very particularly preferably from 70 to 220° C. Depending on the nature of the starting materials and of the final products, these values for residence time and temperature may also have other preferred ranges.

The resultant homogeneous, mostly crumbly material can be discharged continuously. Optionally, a continuous subsequent reaction may be carried out downstream, or otherwise the hot product is cooled (e.g. on a cooling belt) and subjected to finishing (e.g. grinding), if required.

Units which are particularly suitable for the process of the invention and whose use is preferred are extruders, such as single- or multiscrew extruders, in particular twin-screw extruders, planetary gear extruders, and ring extruders, intensive kneaders, intensive mixers, and static mixers. The abovementioned extruders are particularly preferred.

It is surprising that the reaction, which in the batch process needs up to 2 hours, proceeds to completion in a few seconds in the units mentioned above. Furthermore, the form in which the product is produced is solid and to a greater or lesser extent particulate, and, after cooling, the product can be subjected to further treatment (e.g. milling), or else sent directly to storage (e.g., silo) or packing (e.g., bagging-off). The fact that brief exposure to heat combined with the mixing action of the assemblies is sufficient for very substantial or complete reaction of the reactants is of fundamental importance. Suitable equipment in the mixing chambers of the units and suitable design of the screw geometries permit intensive and rapid mixing at the same time as intensive heat exchange. Secondly, uniform longitudinal through-flow is provided, with maximum uniformity of residence time. In addition, there has to be the ability to control to different temperatures in each of the sections or casings of the device.

The reactants are generally fed to the assemblies in separate streams of material. If there are more than two streams of material, these may also be introduced in a combination. The streams of materials may also be divided, and thus introduced to the units in varying proportions at different locations. This method permits the controlled setting of concentration gradients, which can bring about completion of the reaction. The entry points and the time of entry for the reactant streams is sequence-variable and can be time-shifted.

Two or more units may be combined for the purpose of pre-reaction and/or completion of the reaction.

The cooling downstream of the rapid reaction can be integrated into the reaction section to give an embodiment using two or more casings, as is the case with extruders or Conterna machines. Use may also be made of: tube bundles, coiled tubes, cooling rollers, air conveyors, or conveyor belts composed of metal.

Depending on the viscosity of the product leaving the units or the after-reaction zone, the first finishing process uses appropriate means mentioned above for further cooling to a suitable temperature. This is then followed by pelletization or else comminution to a desired particle size by means of a roller crusher, pinned disk mill, hammer mill, grinding mill with size classification, flaking rollers, or the like.

The invention also provides the polymeric composition obtained by a solvent-free continuous process through a conversion involving

A) at least one polymer,

B) amounts of from 0.5 to 50% by weight, based on the weight of A and B, of at least one thermoset,

by reacting, in the polymer matrix A, of

1) at least one starting component having NH₂ groups and

2) at least one starting component having NCO groups, where B1 and B2 simultaneously and independently have functionality ≧2, and at least one starting component with functionality >2 is present in amounts of from 0.5 to 100% by weight, based on the weight of B, in an extruder, intensive kneader, intensive mixer, or static mixer, through intensive mixing and rapid reaction by briefly heating and with subsequent isolation of the final product by cooling.

The composition of the invention is used as main component, underlying component, or added component, for applications in coating compositions, adhesives, and sealants and insulating materials.

The examples below provide further illustration of the invention:

### EXAMPLES

### 1. Preparation of Polyurea in Crystalline Polyester through Reaction of a Solution of IPDI Isocyanurate in Isophorone Diisocyanate (IPDI) with Isophoronediamine (IPD)

The polyurea is prepared from a mixture of 40% by weight of IPDI isocyanurate and 60% by weight of IPDI as isocyanate component and IPD as amine.

The reaction takes place in the crystalline polyester DYNACOLL 7390. The proportion of DYNACOLL 7390 in the entire mixing specification is 79.8% by weight.

The molar ratio of NCO groups to NH₂ groups is 1:1. Besides the NH₂ groups, there are OH groups present stemming from the polyester (OH value 31.8 mg KOH/g).

15.99 kg/h of the polyester is fed in the form of a coarse powder into the first barrel section of a co-rotating twin-screw extruder.

The extruder has barrel sections which are separately temperature-controllable (heatable and coolable).

Barrel section 1 is temperature-controlled to 30° C., barrel 2 to 80° C., and the downstream barrel sections to 120-190° C.

The isocyanate mixture is fed into barrel section 6 at a throughput rate of 2.66 kg/h with an inlet temperature of from 60 to 80° C.

The diamine is fed into barrel section 3 at a throughput rate of 1.38 kg/h with an inlet temperature of from 70 to 95° C.

The total throughput here is 20.03 kg/h.

The discharge temperature is from 100 to 115° C.

The extruder rotation rate is from 350 to 450 rpm.

The product is discharged as a white paste, which is cooled and hardened on a cooling belt.

### 2. Preparation of Polyurea in Amorphous Polyester through Reaction of a Solution of IPDI Isocyanurate in Isophorone Diisocyanate (IPDI) with Isophoronediamine (IPD)

The polyurea is prepared from a mixture of 40% by weight of IPDI isocyanurate and 60% by weight of IPDI as isocyanate component and IPD as amine.

The reaction takes place in the amorphous polyester URALAC P1580. The proportion of URALAC P1580 is 79.9% by weight of the entire mixing specification.

The molar ratio of NCO groups to NH₂ groups is 1:1. Besides the NH₂ groups, there are OH groups stemming from the polyester (OH value 78.0 mg KOH/g).

15.99 kg/h of the polyester is fed in the form of a coarse powder into the first barrel section of a co-rotating twin-screw extruder.

The extruder has barrel sections which are separately temperature-controllable (heatable and coolable).

Barrel section 1 is temperature-controlled to 30° C., barrel 2 to 80° C., and the downstream barrel sections to 120-190° C.

The isocyanate mixture is fed into barrel section 6 at a throughput rate of 2.66 kg/h with an inlet temperature of from 60 to 80° C.

The diamine is fed into barrel section 3 at a throughput rate of 1.37 kg/h with an inlet temperature of from 70 to 95° C.

The total throughput here is 20.02 kg/h.

The discharge temperature is from 170 to 260° C.

The extruder rotation rate is from 350 to 450 rpm.

The product is discharged as a milky white, viscous film, which is cooled and hardened on a cooling belt.

Obviously, numerous modifications and variations of the present invention are possible in light of the above teachings. It is therefore to be understood that within the scope of the appended claims, the invention may be practiced otherwise than as specifically described herein.

DE 10221049.7, May 10, 2002, is hereby incorporated by reference.

1. A process for the solvent-free continuous preparation of a polymeric composition through a conversion comprising
A) at least one polymer,
B) amounts of from 0.5 to 50% by weight, based on the weight of A and B, of at least one thermoset,
reacting in the polymer matrix A, during the above-mentioned conversion, of
1) at least one starting component having NH₂ groups and
2) at least one starting component having NCO groups, where B1 and B2 simultaneously and independently have functionality ≧2, and at least one starting component with functionality >2 is present in amounts of from 0.5 to 100% by weight, based on the weight of B, in an extruder, intensive kneader, intensive mixer, or static mixer, through intensive mixing and rapid reaction by briefly heating and with subsequent cooling to isolate the final product by cooling.

2. The process as claimed in claim 1, wherein said at least one polymer A has a functionality ≧2.

3. The process as claimed in claim 1, wherein said at least one polymer A has OH groups and an OH functionality ≧2.

4. The process as claimed in claim 1, wherein polymer A is selected from the group consisting of polyolefins, polybutadienes, polystyrenes, polysiloxanes, polyamides, and mixtures thereof.

5. The process as claimed in claim 3, wherein polymer A is selected from the group consisting of polyacrylates and polyesters having OH groups, and mixtures thereof.

6. The process as claimed in claim 3, wherein polymer A is selected from the group consisting of amorphous polyesters, (semi)crystalline polyesters and mixtures therof.

7. The process as claimed in claim 3, wherein polymer A is selected from the group consisting of amorphous polyesters with a Tg of 35 to 85° C., a melting range from 60 to 110° C., with a molecular weight from 2000 to 7000, and an OH value from 15 to 200 mg KOH/g.

8. The process as claimed in claim 3, wherein polymer A is selected from the group consisting of crystalline polyesters a Tg from −50 to 40° C., a melting range from 60 to 130° C., a molecular weight from 1800 to 6500, and an OH value from 15 to 130 mg KOH/g.

9. The process as claimed in claim 3, wherein polymer A is selected from the group consisting of polyesters containing OH groups comprised of starting components selected from the group consisting of succinic, adipic, suberic, azelaic, sebacic, phthalic, terephthalic, isophthalic, trimellitic, pyromellitic, tetrahydrophthalic, hexahydrophthalic, hexahydroterephthalic, di- or tetrachlorophthalic, endomethylenetetrahydrophthalic, glutaric, or 1,4-cyclohexanedicarboxylic acid, their anhydrides and/or esters, and mixtures thereof.

10. The process as claimed in claim 3, wherein polymer A is selected from the group consisting of polyesters containing OH groups comprised of diols and/or polyols selected from the group consisting of monoethylene glycol, propylene 1,2- or 1,3-glycol, butylene 1,4- or 2,3-glycol, di-β-hydroxyethylbutanediol, 1,5-pentanediol, 1,6-hexanediol, 1,8-octanediol, decanediol, dodecanediol, neopentyl glycol, cyclohexanediol, 3(4),8(9)-bis(hydroxymethyl)tricyclo[5.2.1.0^{2,6}]decane (Dicidol), bis(1,4-hydroxymethyl)cyclohexane, 2,2-bis(4-hydroxycyclohexyl)propane, 2,2-bis[4-(β-hydroxyethoxy)phenyl]propane, 2-methyl-1,3-propanediol, 2-methyl-1,5-pentanediol, 2,2,4(2,4,4)-trimethyl-1,6-hexanediol, glycerol, trimethylolpropane, trimethylolethane, 1,2,6-hexanetriol, 1,2,4-butanetriol, tris(β-hydroxyethyl) isocyanurate, pentaerythritol, mannitol, sorbitol, diethylene glycol, triethylene glycol, tetraethylene glycol, dipropylene glycol, polypropylene glycols, polybutylene glycols, xylylene glycol, the neopentyl glycol ester of hydroxypivalic acid, and mixtures thereof.

11. The process as claimed in claim 3, wherein polymer A is selected from the group consisting of polyacrylates containing OH groups with an OH value of from 20 to 150 mg KOH/g, a molecular weight of from 1800 to 6000, and a Tg of from 30 to 90° C.

12. The process as claimed in claim 1, wherein B1 is selected from the group consisting of aliphatic, cycloaliphatic, araliphatic and aromatic, isocyanates and isocyanurates, and mixtures thereof.

13. The process as claimed in claim 1, wherein B1 is selected from the group consisting of cyclohexane diisocyanates, methylcyclohexane diisocyanates, ethylcyclohexane diisocyanates, propylcyclohexane diisocyanates, methyldiethylcyclohexane diisocyanates, phenylene diisocyanates, tolylene diisocyanates, bis(isocyanatophenyl)methane, propane diisocyanates, butane diisocyanates, pentane diisocyanates, hexane diisocyanates, such as hexamethylene diisocyanate (HDI) or 1,5-diisocyanato-2-methylpentane (MPDI), heptane diisocyanates, octane diisocyanates, nonane diisocyanates, such as 1,6-diisocyanato-2,4,4-trimethylhexane or 1,6-diisocyanato-2,2,4-trimethylhexane (TMDI), nonane triisocyanates, such as 4-isocyanatomethyl-1,8-octane diisocyanate (TIN), decane di- or triisocyanates, undecane di- or triisocyanates, dodecane di- or triisocyanates, isophorone diisocyanate (IPDI), bis(isocyanatomethylcyclohexyl)methane (H₁₂MDI), isocyantomethyl methylcyclohexyl isocyanates, 2,5(2,6)-bis(isocyanatomethyl)bicyclo[2.2.1]heptane (NBDI), 1,3-bis(isocyanatomethyl)cyclohexane (1,3-H₆-XDI), or 1,4-bis(isocyanatomethyl)cyclohexane (1,4-H₆-XDI), their isocyanurates and mixtures thereof.

14. The process as claimed in claim 1, wherein B1 is selected from the group consisting of isophorone diisocyanate (IPDI), hexamethylene diisocyanate (HDI), their isocyanurates, and mixtures thereof.

15. The process as claimed in claim 1, wherein B2 is selected from the group consisting of aliphatic amines, cycloaliphatic amines, araliphatic amines, aromatic diamines, and mixtures thereof.

16. The process as claimed in claim 1, wherein B2 is selected from the group consisting of 1,2-ethylenediamine, 1,2-propylenediamine, 1,3-propylenediamine, 1,2-butylenediamine, 1,3-butylenediamine, 1,4-butylenediamine, 2-(ethylamino)ethylamine, 3-(methylamino)propylamine, 3-(cyclohexylamino)propylamine, 4,4′-diaminodicyclohexylmethane, isophoronediamine (IPD), 4,7-dioxadecane-1,10-diamine, N-(2-aminoethyl)-1,2-ethanediamine, N-(3-aminopropyl)-1,3-propanediamine, N,N″-1,2-ethanediylbis(1,3-propanediamine), or else of hexamethylenediamines, which may be substituted by one or more C₁-C₄-alkyl radicals, and mixtures thereof.

17. The process as claimed in claim 1, wherein thermoset B comprises IPDI, HDI isocyanurate, and isophoronediamine (IPD).

18. The process as claimed in claim 1, wherein thermoset B comprises the isocyanurate of IPDI and IPD.

19. The process as claimed in claim 1, wherein thermoset B comprises a mixture of IPDI, IPDI isocyanurate and IPD.

20. The process as claimed in claim 1, wherein thermoset B comprises IPDI isocyanurate, HDI, and IPD.

21. The process as claimed in claim 1, wherein thermoset B comprises HDI, HDI isocyanurate, and IPD.

22. The process as claimed in claim 1, wherein thermoset B comprises IPDI isocyanurate, HDI isocyanurate, and IPD.

23. The process as claimed in claim 1, wherein thermoset B comprises IPDI, IPDI isocyanurate, HDI, and HDI isocyanurate.

24. The process as claimed in claim 1, wherein the reaction to form thermoset B takes place with an NCO/NH₂ ratio of from 0.8 to 1.2:1.

25. The process as claimed in claim 1, wherein thermoset B has a molecular weight of at least 4000 and comprises at least 8% by weight of isocyanurate(s) and/or amine(s) with functionality >2.

26. The process as claimed in claim 1, wherein from 0.5 to 50% by weight of thermoset B, based on the weight of A and B, is present in the polymeric composition.

27. The process as claimed in claim 1, wherein the reaction is carried out in a single-, twin-, or multiscrew extruder, ring extruder, or planetary gear extruder.

28. The process as claimed in claim 1, wherein the reaction is carried out in a twin-screw extruder.

29. The process as claimed in claim 1, wherein the reaction is carried out in an intensive mixer or intensive kneader.

30. The process as claimed in claim 1, wherein the reaction is carried out in a static mixer.

31. The process as claimed in claim 1, wherein the reaction is carried out in an extruder, intensive kneader, intensive mixer, or static mixer with two or more identical or different casings which can be thermally controlled independently of one another.

32. The process as claimed in claim 31, wherein the temperature in the extruder, intensive kneader, intensive mixer, or static mixer is from 10 to 325° C.

33. The process as claimed in claim 1, wherein as a result of appropriate equipment in the mixing chambers and design of screw geometry, the extruder or intensive kneader firstly gives rapid, thorough mixing and rapid reaction together with intensive heat exchange and, secondly, produces uniform longitudinal through-flow with maximum uniformity of residence time.

34. The process as claimed in claim 1, wherein the reaction takes place in the presence of catalyst(s) and/or additive(s).

35. The process as claimed in claim 1, wherein the starting materials and/or catalyst(s) and/or additive(s) are fed together or in separate streams of materials, in liquid or solid form, to the extruder, intensive kneader, intensive mixer, or static mixer.

36. The process as claimed in claim 35, wherein the additive(s) are combined with the starting materials to give one stream of materials.

37. The process as claimed in claim 35, wherein if there are more than two reactant streams, these are introduced in the form of a combination.

38. The process as claimed in claim 35, wherein one or both reactant streams are divided.

39. The process as claimed in claim 35, wherein catalyst(s) is/are combined with one of the reactant streams, or is/are present in solution in one of the streams.

40. The process as claimed in claim 35, wherein additive(s) is/are combined with one of the reactant streams, or is present in solution in one of the streams.

41. The process as claimed in claim 35, wherein the entry point for the reactant streams can be sequence-variable and time-shifted.

42. The process as claimed in claim 1, wherein an after-reaction is carried out.

43. The process as claimed in claim 42, wherein the after-reaction is carried out in a continuously operated system.

44. The process as claimed in claim 1, wherein depending on the viscosity of the product leaving the extruder, intensive kneader, intensive mixer, or static mixer, and/or the after-reaction zone, the finishing process begins with further cooling to a temperature adequate for subsequent draw-off/silo storage.

45. The process as claimed in claim 1, wherein the residence time of the starting materials is from 3 seconds to 15 minutes.

46. The process as claimed in claim 1, wherein the reaction takes place at temperatures of from 25 to 325° C.

47. A polymeric composition obtained by a solvent-free continuous process through a conversion comprising
A) at least one polymer,
B) amounts of from 0.5 to 50% by weight, based on the weight of A and B, of at least one thermoset,
reacting in the polymer matrix A, during the abovementioned conversion, of
1) at least one starting component having NH₂ groups and
2) at least one starting component having NCO groups, where B1 and B2 simultaneously and independently have functionality ≧2, and at least one starting component with functionality >2 is present in amounts of from 0.5 to 100% by weight, based on the weight of B, in an extruder, intensive kneader, intensive mixer, or static mixer, through intensive mixing and rapid reaction by briefly heating and with subsequent cooling to isolate the final product.

48. A coating composition, adhesive, sealant or insulating material comprising the polymeric composition as claimed in claim 47.

49. The process as claimed in claim 42, wherein the after-reaction is carried out in a tubular reactor, stirred or unstirred holding vessel a tube bundle.

50. The process as claimed in claim 1, wherein the residence time of the starting materials is from 3 seconds to 5 minutes.

51. The process as claimed in claim 1, wherein the residence time of the starting materials is from 5 to 180 seconds.

52. The process as claimed in claim 1, wherein the reaction takes place at temperatures of from 50 to 250° C.

53. The process as claimed in claim 1, wherein the reaction takes place at temperatures of from 70 to 220° C.
